(19) United States
(12) Patent Application Publication
(10) Pub. No.: US 2022/0215607 A1
(43) Pub. Date: Jul. 7, 2022

(54) METHOD AND APPARATUS FOR DRIVING INTERACTIVE OBJECT AND DEVICES AND STORAGE MEDIUM

(71) Applicant: Beijing Sensetime Technology Development Co., Ltd., Beijing (CN)

(72) Inventor: Lin SUN, Beijing (CN)

(21) Appl. No.: 17/703,499

(22) Filed: Mar. 24, 2022

Related U.S. Application Data
(63) Continuation of application No. PCT/CN2020/104593, filed on Jul. 24, 2020.

(30) Foreign Application Priority Data
Nov. 28, 2019 (CN) 201911193989.1

(51) Int. Cl. G06T 13/40; G06T 7/70; G06T 15/20; G06F 3/01

(52) U.S. Cl. CPC G06T 13/40; G06F 3/011; G06T 15/20; G06T 7/70

(57) ABSTRACT

Methods, apparatus, devices, and computer-readable storage media for driving interactive objects are provided. In one aspect, a method includes: obtaining a first image of surroundings of a display device, the display device being configured to display an interactive object and a virtual space where the interactive object is located; obtaining a first position of a target object in the first image; with a position of the interactive object in the virtual space as a reference point, determining a mapping relationship between the first image and the virtual space; and driving the interactive object to execute an action according to the first position and the mapping relationship.

### CROSS-REFERENCE TO RELATED APPLICATIONS

The present disclosure is a continuation of PCT International Application No. PCT/CN2020/104593, filed on Jul. 24, 2020, which claims priority to Chinese Patent Application No. 2019111939891, filed on Nov. 28, 2019, the entire contents of which are incorporated herein by reference.

### TECHNICAL FIELD

The present disclosure relates to the field of computer technologies, and in particular to methods and apparatus for driving an interactive object and devices and storage media.

### BACKGROUND

Human-machine interaction is usually realized by performing input using buttons, touches and voices, and responding to the input by presenting images, texts or virtual characters on a display screen. At present, the virtual characters are mostly acquired through improvements based on voice assistants, and only output voice, and therefore, the interaction of a user and a virtual character is superficial.

### SUMMARY

The embodiments of the present disclosure provide a solution of driving an interactive object.

According to an aspect of the present disclosure, there is provided a method of driving interactive objects to interact with target objects. The method includes: obtaining a first image of surroundings of a display device, where the display device is configured to display an interactive object and a virtual space where the interactive object is located; obtaining a first position of a target object in the first image; with a position of the interactive object in the virtual space as a reference point, determining a mapping relationship between the first image and the virtual space; and driving the interactive object to execute an action according to the first position and the mapping relationship.

In combination with any one implementation of the present disclosure, driving the interactive object to execute the action according to the first position and the mapping relationship includes: obtaining a corresponding second position of the target object in the virtual space by mapping the first position to the virtual space based on the mapping relationship; driving the interactive object to execute the action according to the corresponding second position.

In combination with any one implementation of the present disclosure, driving the interactive object to execute the action according to the corresponding second position includes: determining a first relative angle between the target object mapped to the virtual space and the interactive object according to the corresponding second position; determining a respective weight for each of one or more body parts of the interactive object to execute the action; according to the first relative angle and the respective weight, driving each of the one or more body parts of the interactive object to rotate a corresponding deflection angle, such that the interactive object faces toward the target object mapped to the virtual space.

In combination with any one implementation of the present disclosure, image data of the virtual space and image data of the interactive object are obtained by a virtual camera device.

In combination with any one implementation of the present disclosure, driving the interactive object to execute the action according to the corresponding second position includes: moving a position of the virtual camera device in the virtual space to the corresponding second position; and setting a sight line of the interactive object to be aligned with the virtual camera device.

In combination with any one implementation of the present disclosure, driving the interactive object to execute the action according to the corresponding second position includes: driving the interactive object to execute the action of moving the sight line to the corresponding second position.

In combination with any one implementation of the present disclosure, driving the interactive object to execute the action according to the first position and the mapping relationship includes: obtaining a second image by mapping the first mage to the virtual space based on the mapping relationship; dividing the first image into a plurality of first sub-regions, and dividing the second image into a plurality of second sub-regions corresponding to the plurality of first sub-regions respectively; determining a target first sub-region where the target object is located in the plurality of first sub-regions of the first image, and determining a target second sub-region in the plurality of second sub-regions of the second image based on the target first sub-region; and driving the interactive object to execute the action according to the target second sub-region.

In combination with any one implementation of the present disclosure, driving the interactive object to execute the action according to the target second sub-region includes: determining a second relative angle between the interactive object and the target second sub-region; and driving the interactive object to rotate the second relative angle such that the interactive object faces toward the target second sub-region.

In combination with any one implementation of the present disclosure, with the position of the interactive object in the virtual space as the reference point, determining the mapping relationship between the first image and the virtual space includes: determining a proportional relationship between a unit pixel distance of the first image and a unit distance of the virtual space; determining a corresponding mapping plane of a pixel plane of the first image in the virtual space, where the mapping plane is obtained by projecting the pixel plane of the first image to the virtual space; and, determining an axial distance between the interactive object and the mapping plane.

In combination with any one implementation of the present disclosure, determining the proportional relationship between the unit pixel distance of the first image and the unit distance of the virtual space includes: determining a first proportional relationship between the unit pixel distance of the first image and the unit distance of a true space; determining a second proportional relationship between the unit distance of the true space and the unit distance of the virtual space; and determining the proportional relationship between the unit pixel distance of the first image and the unit distance of the virtual space according to the first proportional relationship and the second proportional relationship.

In combination with any one implementation of the present disclosure, the first position of the target object in the first image includes at least one of a position of a face of the target object or a position of a body of the target object.

According to an aspect of the present disclosure, there is provided an apparatus for driving an interactive object. The apparatus includes: a first obtaining unit, configured to obtain a first image of surroundings of a display device, where the display device is configured to display an interactive object and a virtual space where the interactive object is located; a second obtaining unit, configured to obtain a first position of a target object in the first image; a determining unit, configured to, with a position of the interactive object in the virtual space as a reference point, determine a mapping relationship between the first image and the virtual space; and a driving unit, configured to drive the interactive object to execute an action according to the first position and the mapping relationship.

According to an aspect of the present disclosure, there is provided a display device, including a transparent display screen, at least one processor; and one or more memories coupled to the at least one processor and storing programming instructions for execution by the at least one processor to perform operations including: obtaining a first image of surroundings of the display device, where the display device is configured to display, on the transparent display screen, an interactive object and a virtual space where the interactive object is located; obtaining a first position of a target object in the first image; with a position of the interactive object in the virtual space as a reference point, determining a mapping relationship between the first image and the virtual space; and driving the interactive object to execute an action according to the first position and the mapping relationship.

According to an aspect of the present disclosure, there is provided an electronic device, including at least one processor; and one or more memories coupled to the at least one processor and storing programming instructions for execution by the at least one processor to perform operations including: obtaining a first image of surroundings of a display device, where the display device is configured to display an interactive object and a virtual space where the interactive object is located; obtaining a first position of a target object in the first image; with a position of the interactive object in the virtual space as a reference point, determining a mapping relationship between the first image and the virtual space; and driving the interactive object to execute an action according to the first position and the mapping relationship.

According to an aspect of the present disclosure, there is provided a computer readable storage medium storing computer programs thereon, where the programs are executed by a processor to implement the method of driving an interactive object according to any one implementation of the present disclosure.

In the method and apparatus for driving an interactive object, the device and the computer readable storage medium according to one or more embodiments of the present disclosure, the first image of the surroundings of the display device is obtained, and the first position of the target object interacting with the interactive object in the first image and the mapping relationship between the first image and the virtual space displayed in the display device are obtained, and then the interactive object is driven to execute an action based on the first position and the mapping relationship such that the interactive object can maintain face-to-face with the target object, thus making the interaction between the target object and the interactive object more vivid and improving the interaction experiences for the target object.

### BRIEF DESCRIPTION OF THE DRAWINGS

In order to more clearly describe the technical solutions in one or more embodiments or in the prior art, the accompanying drawings required for descriptions of the embodiments or the prior arts are briefly introduced below. Apparently, the accompanying drawings described below are merely some embodiments recorded in one or more embodiments of the present disclosure, and those skilled in the art may obtain other drawings based on these drawings without making creative work.

FIG. 1 is a schematic diagram illustrating a display device in a method of driving an interactive object according to at least one embodiment of the present disclosure.

FIG. 2 is a flowchart illustrating a method of driving an interactive object according to at least one embodiment of the present disclosure.

FIG. 3 is a schematic diagram illustrating a relative position of a second position and an interactive object according to at least one embodiment of the present disclosure.

FIG. 4 is a flowchart illustrating a method of driving an interactive object according to at least one embodiment of the present disclosure.

FIG. 5 is a flowchart illustrating a method of driving an interactive object according to at least one embodiment of the present disclosure.

FIG. 6 is a flowchart illustrating a method of driving an interactive object according to at least one embodiment of the present disclosure.

FIG. 7 is structural schematic diagram illustrating an apparatus for driving an interactive object according to at least one embodiment of the present disclosure.

FIG. 8 is a structural schematic diagram illustrating an electronic device according to at least one embodiment of the present disclosure.

### DETAILED DESCRIPTION OF THE EMBODIMENTS

Embodiments will be described in detail herein, with the illustrations thereof represented in the drawings. When the following descriptions involve the drawings, like numerals in different drawings refer to like or similar elements unless otherwise indicated. Embodiments described in the following embodiments do not represent all embodiments consistent with the present disclosure. Rather, they are merely embodiments of apparatuses and methods consistent with some aspects of the present disclosure as detailed in the appended claims.

The term “and/or” herein only is a description of an association relationship of associated objects, which means that there may be three relationships. For example, A and/or B means A exists alone, or A and B exist at the same time or B exists alone. In addition, the term “at least one” herein refers to any one of multiple or any combination of at least two of multiple. For example, at least one of A, B and C may mean any one or more elements selected from a set formed by A, B and C.

At least one embodiment of the present disclosure provides a method of driving an interactive object. The driving method may be performed by an electronic device such as a terminal device or a server. The terminal device may be a fixed terminal or a mobile terminal, such as a mobile phone, a tablet computer, a game console, a desktop computer, an advertising machine, an all-in-one machine, and a vehicle-mounted terminal. The method may be further implemented by a processor by invoking computer readable instructions stored in a memory.

In the embodiments of the present disclosure, an interactive object may be any object capable of interacting with a target object. The interactive object may be a virtual character, or may be a virtual animal, virtual article, and cartoon image and the like capable of realizing interaction function. The target object may be a user, a robot, or another smart device. The interaction between the interaction object and the target object may be active interaction or passive interaction. In an example, the target object may send a request by making a gesture or another body action to actively trigger the interactive object to interact with the target object. In another example, the interactive object may actively greet the target object or prompt the target object to perform an action, and so on, so as to enable the target object to interact with the interaction object passively.

The interactive object may be displayed by a display device, and the display device may be an electronic device having a display function, such as an all-in-one machine with a display, a projector, a Virtual Reality (VR) device, an Augmented Reality (AR) device, or may be a display device having special display effect.

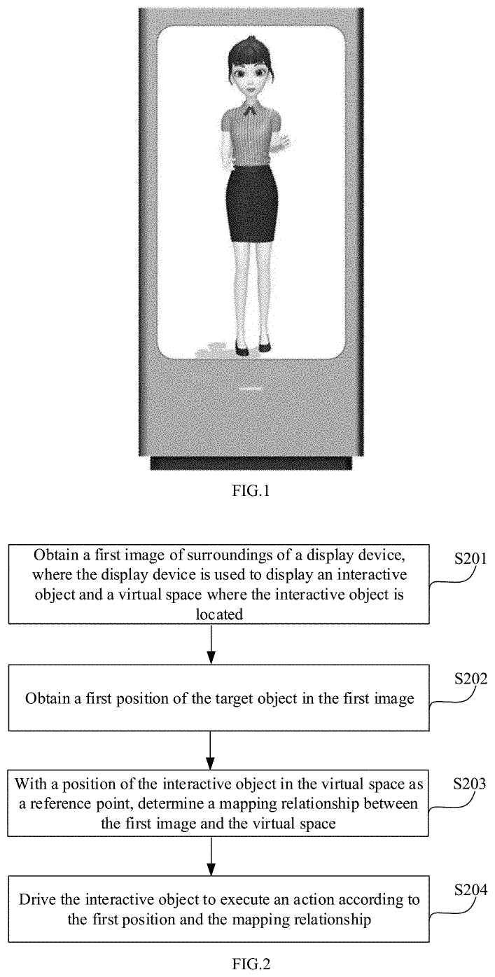

FIG. 1 illustrates a display device according to at least one embodiment of the present disclosure. As shown in FIG. 1, the display device may display a stereoscopic picture on a display screen to present a virtual scenario and an interactive object with a stereoscopic effect. For example, the interactive object displayed on the display screen in FIG. 1 includes a virtual cartoon character. The display screen may also be a transparent display screen. In some embodiments of the present disclosure, the terminal device may also be the above display device with a display screen. A memory and a processor are configured in the display device. The memory is configured to store computer instructions operable on the processor. The processor, when executing the computer instructions, is caused to implement the method of driving an interactive object according to the present disclosure, so as to drive the interactive object displayed in the display screen to execute an action.

In some embodiments, in response to that the display device receives drive data for driving the interactive object to make action, present expression or output voice, the interactive object may make a specified action, expression or utter a specific voice toward the target object. According to an action, expression, identity and preference and the like of the target object of the surroundings of the display device, drive data may be generated to drive the interactive object to respond so as to provide anthropomorphic services for the target object. During an interaction process of the interactive object and the target object, the interactive object possibly cannot accurately obtain a position of the target object, and thus cannot maintain face-to-face communication with the target object, making the interaction between the interactive object and the target object stiff and unnatural. In view of this, at least one embodiment of the present disclosure provides a method of driving an interactive object to improve the interaction experiences between the target object and the interactive object.

FIG. 2 is a flowchart illustrating a method of driving an interactive object according to at least one embodiment of the present disclosure. As shown in FIG. 2, the method includes steps S201 to S204.

At step S201, a first image of surroundings of a display device is obtained, where the display device is used to display an interactive object and a virtual space where the interactive object is located.

The surroundings of the display device include a set scope of the display device in any direction, where the any direction may include, for example, one or more directions of front direction, side direction, rear direction, and upward direction of the display device.

The first image may be collected by using an image collection device. The image collection device may be a camera inside the display device, or a camera independent of the display device. There may be one or more image collection devices.

In some examples, the first image may be one frame of a video stream, or an image obtained in real time.

In an embodiment of the present disclosure, the virtual space may be a virtual scenario presented on a screen of the display device; the interactive object may be a virtual object such as a virtual character, a virtual article and a cartoon image presented in the virtual scenario, which can interact with a target object.

At step S202, a first position of the target object in the first image is obtained.

In an embodiment of the present disclosure, the first image may be input into a pretrained neural network model to perform human face and/or human body detection for the first image so as to detect whether the target object is included in the first image. The target object refers to a user object interacting with the interactive object, for example, a person, an animal or an article capable of executing an action or instruction or the like. The type of the target object is not limited herein.

In response to that a detection result of the first image includes a human face and/or human body (for example, in the form of human face bounding box and/or human body bounding box), the first position of the target object in the first image may be determined by obtaining a position of the human face and/or human body in the first image. Those skilled in the art should understand that the first position of the target object in the first image may also be obtained in another manner, which is not limited herein.

At step S203, with a position of the interactive object in the virtual space as a reference point, a mapping relationship between the first image and the virtual space is determined.

The mapping relationship between the first image and the virtual space refers to a size and a position of the first image relative to the virtual space when the first image is mapped to the virtual space. With a position of the interactive object in the virtual space as a reference point, determining the mapping relationship refers to a size and a position of the first image mapped to the virtual space under the view angle of the interactive object.

At step S204, the interactive object is driven to execute an action according to the first position and the mapping relationship.

According to the first position of the target object in the first image and the mapping relationship between the first image and the virtual space, a position of the target object mapped to the virtual space relative to the interactive object under the view angle of the interactive object may be determined. Based on the relative position, the interactive object is driven to execute the action, for example, the interactive object is driven to turn around, turn sideways and turn head etc. such that the interactive object maintains face-to-face with the target object, thus making the interaction between the target object and the interactive object more vivid and improving the interaction experiences for the target object.

In an embodiment of the present disclosure, the first image of the surroundings of the display device is obtained, and the first position of the target object interacting with the interactive object in the first image and the mapping relationship between the first image and the virtual space displayed by the display device are obtained; the interactive object is driven to execute the action based on the first position and the mapping relationship, such that the interactive object can maintain face-to-face with the target object, thus making the interaction between the target object and the interactive object more vivid and improving the interaction experiences for the target object.

In an embodiment of the present disclosure, the virtual space and the interactive object are obtained by displaying image data obtained by a virtual camera device on a screen of the display device. Image data of the virtual space and image data of the interactive object may be obtained by the virtual camera device or invoked by the virtual camera device. The virtual camera device is a camera application or camera assembly applied to a 3D software and used to present a 3D image on a screen, and the virtual space is obtained by displaying the 3D image obtained by the virtual camera device on the screen. Therefore, a view angle of the target object may be understood as a view angle of the virtual camera device in the 3D software.

A space where the target object and the image collection device are located may be understood as a true space, and the first image containing the target object may be understood as corresponding to a pixel space; the interactive object and the virtual camera device correspond to the virtual space. A correspondence between pixel space and true space may be determined based on a distance between the target object and the image collection device and a parameter of the image collection device; whereas a correspondence between true space and virtual space may be determined based on a parameter of the display device and a parameter of the virtual camera device. After the correspondence between pixel space and true space and the correspondence between true space and virtual space are determined, a correspondence between pixel space and virtual space may be determined, that is, the mapping relationship between the first image and the virtual space may be determined.

In some embodiments, with a position of the interactive object in the virtual space as a reference point, a mapping relationship between the first image and the virtual space may be determined.

Firstly, a proportional relationship n between unit pixel distance of the first image and unit distance of the virtual space is determined.

The unit pixel distance refers to a size or length corresponding to each pixel; the unit distance of the virtual space refers to a unit size or length in the virtual space.

In an example, the proportional relationship n may be determined by determining a first proportional relationship n₁ between unit pixel distance of the first image and unit distance of the true space, and a second proportional relationship n₂ between unit distance of the true space and unit distance of the virtual space. The unit distance of the true space refers to a unit size or length in the true space. Herein, the sizes of the unit pixel distance, the unit distance of the virtual space, and the unit distance of the true space may be preset and also may be modified.

The first proportional relationship n₁ is obtained through calculation in the formula (1):

$${n}_{1} = d / \sqrt{{a}^{2} + {b}^{2} + {c}^{2}} \qquad ( 1 )$$

where d represents a distance between the target object and the image collection device, and illustratively, may be a distance between a face of the target object and the image collection device, a represents a width of the first image, b represents a height of the first image,

$$c = \frac{b}{2 tan ( {( F O {V}_{1} / 2 )}^{*} c o n )} ,$$

where FOV₁ represents an angle of FOV (field of view) of the image collection device in a vertical direction, and con represents a constant value with which an angle changes to a radian.

The second proportional relationship n₂ is obtained through calculation in the formula (2):

$${n}_{2} = {h}_{s} / {h}_{v} \qquad ( 2 )$$

where hₛ represents a screen height of the display device, hᵥ represents a height of the virtual camera device, hᵥ=tan((FOV₂/2)*con*d_{z}*2), where FOV₂ represents an angle of FOV of the virtual camera device in a vertical direction, con represents a constant value with which an angle changes to a radian, and d_{z} represents an axial distance between the interactive object and the virtual camera device.

The proportional relationship n between unit pixel distance of the first image and unit distance of the virtual space may be obtained through calculation in the formula (3):

$$n = {n}_{1} / {n}_{2} \qquad ( 3 )$$

Next, a corresponding mapping plane of a pixel plane of the first image in the virtual space and an axial distance f_{z} between the interactive object and the mapping plane are determined.

The axial distance f_{z} between the mapping plane and the interactive object may be obtained through calculation in the formula (4):

$${f}_{z} = c * {n}_{1} / {n}_{2} \qquad ( 4 )$$

The mapping relationship between the first image and the virtual space may be determined after determining the proportional relationship n between unit pixel distance of the first image and unit distance of the virtual space and the axial distance f_{z} between the mapping plane and the interactive object in the virtual space.

In some embodiments, a corresponding second position of the target object in the virtual space may be obtained by mapping the first position to the virtual space based on the mapping relationship, and the interactive object is driven to execute the action based on the second position.

A coordinate (fₓ, f_{y}, f_{z}) of the second position in the virtual space may be calculated based on the following formulas:

$${f}_{x} = {r}_{x} * \frac{{n}_{1}}{{n}_{2}} \\ {f}_{y} = {r}_{y} * \frac{{n}_{1}}{{n}_{2}} \\ {f}_{z} = c * \frac{{n}_{1}}{{n}_{2}} \qquad ( 5 )$$

where rₓ and r_{y} are coordinates of the first position of the target object along x and y directions in the first image.

By obtaining the corresponding second position of the target object in the virtual space by mapping the first position of the target object in the first image to the virtual space, a relative position relationship between the target object and the interactive object in the virtual space may be determined. The interactive object is driven to execute the action based on the relative position relationship, such that the interactive object makes action feedback for position change of the target object, thereby improving the interaction experiences for the target object.

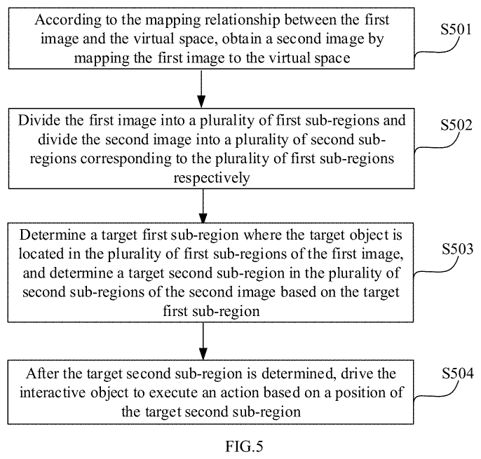

In an example, the interactive object may be driven to execute an action in the following manner as shown in FIG. 4.

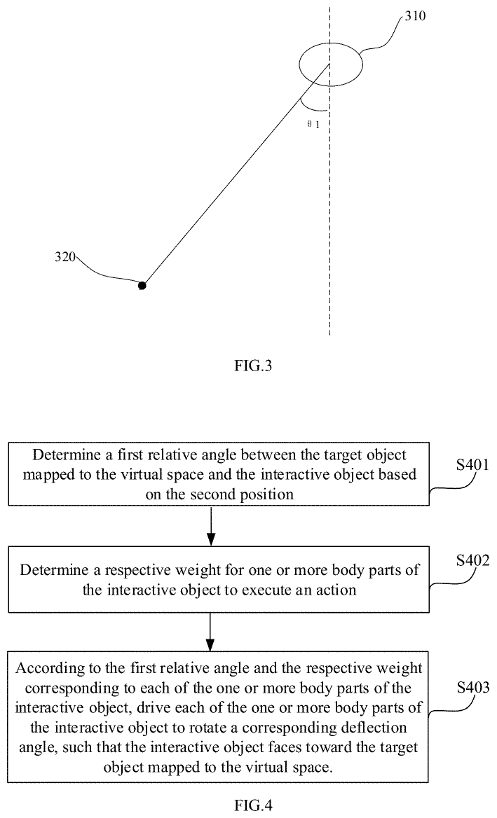

Firstly, at step S401, a first relative angle between the target object mapped to the virtual space and the interactive object is determined based on the second position. The first relative angle refers to an angle between a direction in which the front of the interactive object faces (a direction corresponding to a sagittal section of human body) and the second position. As shown in FIG. 3, 310 represents the interactive object whose front faces in a direction as indicated by dotted line in FIG. 3; 320 represents an coordinate point corresponding to the second position (second position point). An angle θ1 between a line connecting the second position point and the position point of the interactive object (for example, a center of gravity of a transverse section of the interactive object may be determined as a position point of the interactive object) and the direction in which the front of the interactive object faces is the first relative angle.

Next, at step S402, a respective weight for each of one or more body parts of the interactive object to execute an action is determined. The body part of the interactive object refer to a body part involved in action execution. When the interactive object completes one action, for example, turns 90 degrees to face toward an object, its lower body, upper body and head may jointly complete the action. For example, the lower body deflects 30 degrees, the upper body deflects 60 degrees and the head deflects 90 degrees, and thus the interactive object can turn 90 degrees. An amplitude proportion in which each of the one or more body parts deflects is the weight of action execution. As required, a respective weight for one of the body parts to execute the action may be set to higher, and thus the body part will have a larger movement amplitude during action execution, and other body parts have a smaller movement amplitude, so as to jointly complete a designated action. Those skilled in the art should understand that the body parts included in this step and the weights corresponding to various body parts may be specifically set based on an action to be executed and requirement of action effect, or automatically set in a renderer or software.

Finally, at step S403, according to the first relative angle and the respective weight corresponding to each of the one or more body parts of the interactive object, each of the one or more body parts of the interactive object is driven to rotate a corresponding deflection angle, such that the interactive object faces toward the target object mapped to the virtual space.

In an embodiment of the present disclosure, according to the relative angle between the target object mapped to the virtual space and the interactive object and the respective weight for each of the one or more body parts of the interactive object to execute the action, each of the one or more body parts of the interactive object is driven to rotate a corresponding deflection angle. In this way, by different body parts of the interactive object making movements of different amplitudes, an effect that the body of the interactive object faces toward the tracked target object naturally and vividly can be achieved, thus improving the interaction experiences for the target object.

In some embodiments, a sight line of the interactive object may be set to be aligned with the virtual camera device. After the corresponding second position of the target object in the virtual space is determined, the position of the virtual camera device in the virtual space is moved to the corresponding second position. Since the sight line of the interactive object is set to be always aligned with the virtual camera device, the target object may have a feel that the sight line of the interactive object always follows the target object, thus improving the interaction experiences for the target object.

In some embodiments, the interactive object may be driven to execute the action of moving the sight line of the interactive object to the corresponding second position, such that the sight line of the interactive object tracks the target object, thereby improving the interaction experiences for the target object.

In an embodiment of the present disclosure, the interactive object may also be driven to execute the action in the following manner as shown in FIG. 5.

Firstly, at step S501, according to the mapping relationship between the first image and the virtual space, a second image is obtained by mapping the first image to the virtual space. Since the above mapping relationship is generated with the position of the interactive object in the virtual space as a reference point, i.e. based on a view angle of the interactive object, the scope of the second image obtained by mapping the first image to the virtual space may be taken as a field of view of the interactive object.

Next, at step S502, the first image is divided into a plurality of first sub-regions and the second image is divided into a plurality of second sub-regions corresponding to the plurality of first sub-regions respectively. The corresponding herein refers to that the number of the first sub-regions and the number of the second sub-regions are equal, each first sub-region and each second sub-region are in a same proportional relationship in terms of size, and each first sub-region has a corresponding second sub-region in the second image.

The scope of the second image mapped to the virtual space is taken as the field of view of the interactive object, and thus the division of the second image is equivalent to division of the field of view of the interactive object. The sight line of the interactive object may be aligned with each second sub-region in the field of view.

Next, at step S503, a target first sub-region where the target object is located is determined in the plurality of first sub-regions of the first image, and a target second sub-region in the plurality of second sub-regions of the second image is determined based on the target first sub-region. The first sub-region where the face of the target object is located is taken as the target first sub-region, or the first sub-region where the body of the target object is located is taken as the target first sub-region, or the first sub-regions where the face and the body of the target object are located is taken as the target first sub-region. The target first sub-region may include a plurality of first sub-regions.

Next, at step S504, after the target second sub-region is determined, the interactive object is driven to execute an action based on a position of the target second sub-region.

In an embodiment of the present disclosure, by dividing the field of view of the interactive object, a corresponding position region of the target object in the field of view of the interactive object may be determined based on the position of the target object in the first image, thereby quickly and effectively driving the interactive object to make an action.

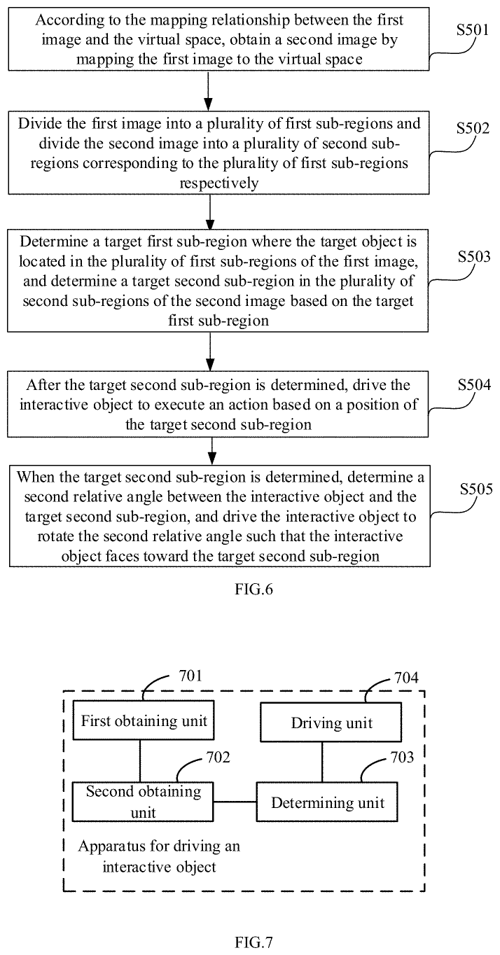

As shown in FIG. 6, in addition to the steps S501 to S504 in FIG. 5, step S505 is further included. At step S505, when the target second sub-region is determined, a second relative angle between the interactive object and the target second sub-region may be determined, and the interactive object is driven to rotate the second relative angle such that the interactive object faces toward the target second sub-region. In this way, the interactive object can always maintain face-to-face with the target object along with movement of the target object. The determination manner of the second relative angle is similar to that of the first relative angle. For example, an angle between a line connecting the center of the target second sub-region and the position point of the interactive object and a direction in which the front of the interactive object faces is determined as the second relative angle. The determination manner of the second relative angle is not limited hereto.

In an example, the interactive object may be driven to entirely rotate the second relative angle, such that the interactive object faces toward the target second sub-region; in another example, as mentioned above, according to the second relative angle and the weight corresponding to each of the one or more body parts of the interactive object, each of the one or more body parts of the interactive object is driven to rotate a corresponding deflection angle such that the interactive object faces toward the target second sub-region.

In some embodiments, the display device may be a transparent display screen which displays an interactive object including a virtual image having stereoscopic effect. When the target object appears behind the display device, that is, behind the interactive object, the second position of the target object obtained by mapping the first position of the target object in the first image to the virtual space is located behind the interactive object. In this case, according to the first relative angle between the direction in which the front of the interactive object faces and the mapped second position, the interactive object is driven to make an action to enable the interactive object to turn around to face toward the target object.

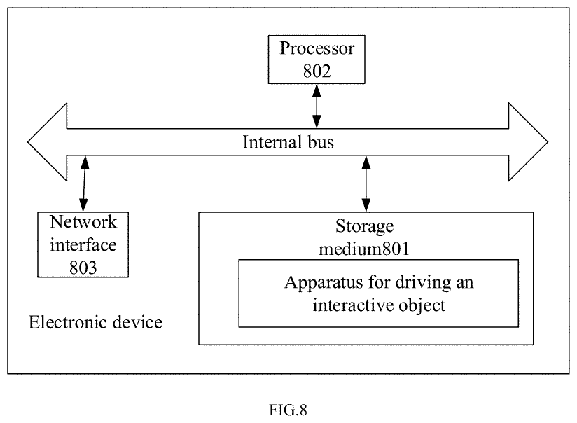

FIG. 7 is a structural schematic diagram illustrating an apparatus for driving an interactive object according to at least one embodiment of the present disclosure. As shown in FIG. 7, the apparatus may include a first obtaining unit 701, a second obtaining unit 702, a determining unit 703 and a driving unit 704.

The first obtaining unit 701 is configured to obtain a first image of surroundings of a display device, where the display device is used to display an interactive object and a virtual space where the interactive object is located; the second obtaining unit 702 is configured to obtain a first position of a target object in the first image; the determining unit 703 is configured to with a position of the interactive object in the virtual space as a reference point, determine a mapping relationship between the first image and the virtual space; the driving unit 704 is configured to drive the interactive object to execute an action according to the first position and the mapping relationship.

In some embodiments, the driving unit 704 is specifically configured to: obtain a corresponding second position of the target object in the virtual space by mapping the first position to the virtual space based on the mapping relationship; drive the interactive object to execute the action according to the corresponding second position.

In some embodiments, when used to drive the interactive object to execute the action according to the second corresponding position, the driving unit 704 is specifically configured to: determine a first relative angle between the target object mapped to the virtual space and the interactive object according to the second corresponding position; determine a respective weight for each of one or more body parts of the interactive object to execute the action; according to the first relative angle and the respective weight, drive each of the one or more body parts of the interactive object to rotate a corresponding deflection angle, such that the interactive object faces toward the target object mapped to the virtual space.

In some embodiments, image data of the virtual space and image data of the interactive object are obtained by a virtual camera device.

In some embodiments, when used to drive the interactive object to execute the action according to the second corresponding position, the driving unit 704 is specifically configured to: move a position of the virtual camera device in the virtual space to the corresponding second position; set a sight line of the interactive object to be aligned with the virtual camera device.

In some embodiments, when used to drive the interactive object to execute the action according to the second corresponding position, the driving unit 704 is specifically configured to: drive the interactive object to execute the action of moving the sight line of the interactive object to the corresponding second position.

In some embodiments, the driving unit 704 is specifically configured to: obtain a second image by mapping the first mage to the virtual space based on the mapping relationship; divide the first image into a plurality of first sub-regions, and divide the second image into a plurality of second sub-regions corresponding to the plurality of first sub-regions respectively; determine a target first sub-region where the target object is located in the first image, and determine a corresponding target second sub-region based on the target first sub-region; drive the interactive object to execute the action according to the target second sub-region.

In some embodiments, when used to drive the interactive object to execute the action according to the target second sub-region, the driving unit 704 is specifically configured to: determine a second relative angle between the interactive object and the target second sub-region; drive the interactive object to rotate the second relative angle such that the interactive object faces toward the target second sub-region.

In some embodiments, the determining unit 703 is specifically configured to: determine a proportional relationship between a unit pixel distance of the first image and a unit distance of the virtual space; determine a corresponding mapping plane of a pixel plane of the first image in the virtual space, where the mapping plane is obtained by projecting the pixel plane of the first image to the virtual space; and, determine an axial distance between the interactive object and the mapping plane.

In some embodiments, when used to determine the proportional relationship between the unit pixel distance of the first image and the unit distance of the virtual space, the determining unit 703 is specifically configured to: determine a first proportional relationship between the unit pixel distance of the first image and the unit distance of a true space; determine a second proportional relationship between the unit distance of the true space and the unit distance of the virtual space; determine the proportional relationship between the unit pixel distance of the first image and the unit distance of the virtual space according to the first proportional relationship and the second proportional relationship.

In some embodiments, the first position of the target object in the first image includes at least one of a position of a face of the target object and a position of a body of the target object.

At least one embodiment of the present disclosure further provides an electronic device. As shown in FIG. 8, the device includes a storage medium 801, a processor 802, and a network interface 803. The storage medium 801 is configured to store computer instructions that can be run on the processor, and the processor is configured to execute the computer instructions to implement the method of driving an interactive object according to any one of the above embodiments of the present disclosure. At least one embodiment of the present disclosure further provides a computer readable storage medium, storing computer programs thereon. The programs are executed by a processor to implement the method of driving an interactive object according to any one of the above embodiments of the present disclosure.

Persons skilled in the art shall understand that one or more embodiments of the present disclosure may be provided as methods, systems, or computer program products. Thus, one or more embodiments of the present disclosure may be adopted in the form of entire hardware embodiments, entire software embodiments or embodiments combining software and hardware. Further, one or more embodiments of the present disclosure may be adopted in the form of computer program products that are implemented on one or more computer available storage media (including but not limited to magnetic disk memory, CD-ROM, and optical memory and so on) including computer available program codes.

Different embodiments in the present disclosure are all described in a progressive manner. Each embodiment focuses on the differences from other embodiments with those like or similar parts among the embodiments referred to each other. Particularly, since data processing device embodiments are basically similar to the method embodiments, the device embodiments are briefly described with relevant parts referred to the descriptions of the method embodiments.

Specific embodiments of the present disclosure are described above. Other embodiments not described herein still fall within the scope of the appended claims. In some cases, the actions or steps recorded in the claims may be performed in a sequence different from the embodiments to achieve a desired result. In addition, processes shown in drawings do not necessarily require a particular sequence or a continuous sequence to achieve the desired result. In some embodiments, multi-task processing and parallel processing are possible or may also be advantageous.

The embodiments of the subject and functional operations described in the present disclosure may be achieved in the following: a digital electronic circuit, a tangible computer software or firmware, a computer hardware including a structure disclosed in the present disclosure or a structural equivalent thereof, or a combination of one or more of the above. The embodiment of the subject described in the present disclosure may be implemented as one or more computer programs, that is, one or more modules in computer program instructions encoded on a tangible non-transitory program carrier for being executed by or controlling a data processing apparatus. Alternatively or additionally, program instructions may be encoded on an artificially-generated transmission signal, such as a machine-generated electrical, optical or electromagnetic signal. The signal is generated to encode and transmit information to an appropriate receiver for execution by the data processing apparatus. The computer storage medium may be a machine readable storage device, a machine readable storage substrate, a random or serial access memory device, or a combination of one or more of the above.

The processing and logic flows described in the present disclosure may be executed by one or more programmable computers executing one or more computer programs to perform corresponding functions by operating input data and generating outputs. The processing and logic flows may be further executed by a dedicated logic circuit, such as a field programmable gate array (FPGA) or an application specific integrated circuit (ASIC), and the apparatus may be further implemented as the dedicated logic circuit.

Computers suitable for executing computer programs include, for example, a general-purpose and/or special-purpose microprocessor, or any other type of central processing unit. Generally, the central processing unit receives instructions and data from a read-only memory and/or random access memory. Basic components of a computer may include a central processing unit for implementing or executing instructions and one or more storage devices for storing instructions and data. Generally, the computer may further include one or more mass storage devices for storing data, such as magnetic disks, magneto-optical disks or optical disks, or the computer is operably coupled to this mass storage device to receive data therefrom or transmit data thereto, or both. However, the computer does not necessarily have such device. In addition, the computer may be embedded in another device, such as a mobile phone, a Personal Digital Assistant (PDA), a mobile audio or video player, a game console, a Global Positioning System (GPS) receiver, or a portable storage device, e.g., a Universal Serial Bus (USB) flash drive, and so on.

Computer readable media suitable for storing computer program instructions and data may include all forms of non-volatile memories, media and memory devices, such as semi-conductor memory devices (e.g., Erasable Programmable Read-Only Memory (EPROM), Electrically Erasable Programmable Read-Only Memory (EEPROM) and flash memory device), magnetic disks (e.g., internal hard disk or removable disk), magneto-optical disks, and CD-ROM and DVD-ROM disks. The processor and the memory may be supplemented by or incorporated into a dedicated logic circuit.

Although many specific implementation details are included in the present disclosure, these details should not be construed as limiting any scope of the present disclosure or the claimed scope, but are mainly used to describe the features of specific embodiments of the particular disclosure. Certain features described in several embodiments of the present disclosure may also be implemented in combination in a single embodiment. On the other hand, various features described in the single embodiment may also be implemented separately or in any appropriate sub-combination in several embodiments. In addition, although the features may function in certain combinations as described above and even be initially claimed as such, one or more features from the claimed combination may be removed from the combination in some cases, and the claimed combination may refer to a sub-combination or a variation of the sub-combination.

Similarly, although the operations are described in a specific order in the drawings, this should not be understood as requiring these operations to be performed in the shown specific order or in sequence, or requiring all of the illustrated operations to be performed, so as to achieve a desired result. In some cases, multi-task processing and parallel processing may be advantageous. In addition, the separation of different system modules and components in the above embodiments should not be understood as requiring such separation in all embodiments. Further, it is to be understood that the described program components and systems may be generally integrated together in a single software product or packaged into a plurality of software products.

Therefore, the specific embodiments of the subject are already described, and other embodiments are within the scope of the appended claims. In some cases, actions recorded in the claims may be performed in a different order to achieve the desired result. In addition, the processing described in the drawings is not necessarily performed in the shown specific order or in sequence, so as to achieve the desired result. In some implementations, multi-task processing and parallel processing may be advantageous.

The foregoing disclosure is merely illustrative of preferred embodiments of one or more embodiments of the present disclosure but not intended to limit one or more embodiments of the present disclosure, and any modifications, equivalent substitutions and improvements thereof made within the spirit and principles of one or more embodiments in the present disclosure shall be encompassed in the scope of protection of one or more embodiments in the present disclosure.

1. A method of driving interactive objects to interact with target objects, the method comprising:
obtaining a first image of surroundings of a display device, wherein the display device is configured to display an interactive object and a virtual space where the interactive object is located;
obtaining a first position of a target object in the first image;
with a position of the interactive object in the virtual space as a reference point, determining a mapping relationship between the first image and the virtual space; and
driving the interactive object to execute an action according to the first position and the mapping relationship.

2. The method of claim 1, wherein driving the interactive object to execute the action according to the first position and the mapping relationship comprises:
obtaining a corresponding second position of the target object in the virtual space by mapping the first position to the virtual space based on the mapping relationship;
driving the interactive object to execute the action according to the corresponding second position.

3. The method of claim 2, wherein driving the interactive object to execute the action according to the corresponding second position comprises:
determining a first relative angle between the target object mapped to the virtual space and the interactive object according to the corresponding second position;
determining a respective weight for each of one or more body parts of the interactive object to execute the action;
according to the first relative angle and the respective weight, driving each of the one or more body parts of the interactive object to rotate a corresponding deflection angle, such that the interactive object faces toward the target object mapped to the virtual space.

4. The method of claim 2, wherein image data of the virtual space and image data of the interactive object are obtained by a virtual camera device.

5. The method of claim 4, wherein driving the interactive object to execute the action according to the corresponding second position comprises:
moving a position of the virtual camera device in the virtual space to the corresponding second position; and
setting a sight line of the interactive object to be aligned with the virtual camera device.

6. The method of claim 2, wherein driving the interactive object to execute the action according to the corresponding second position comprises:
driving the interactive object to execute the action of moving a sight line of the interactive object to the corresponding second position.

7. The method of claim 1, wherein driving the interactive object to execute the action according to the first position and the mapping relationship comprises:
obtaining a second image by mapping the first mage to the virtual space based on the mapping relationship;
dividing the first image into a plurality of first sub-regions, and dividing the second image into a plurality of second sub-regions corresponding to the plurality of first sub-regions respectively;
determining a target first sub-region where the target object is located in the plurality of first sub-regions of the first image, and determining a target second sub-region in the plurality of second sub-regions of the second image based on the target first sub-region; and
driving the interactive object to execute the action according to the target second sub-region.

8. The method of claim 7, wherein driving the interactive object to execute the action according to the target second sub-region comprises:
determining a second relative angle between the interactive object and the target second sub-region; and
driving the interactive object to rotate the second relative angle such that the interactive object faces toward the target second sub-region.

9. The method of claim 1, wherein, with the position of the interactive object in the virtual space as the reference point, determining the mapping relationship between the first image and the virtual space comprises:
determining a proportional relationship between a unit pixel distance of the first image and a unit distance of the virtual space;
determining a corresponding mapping plane of a pixel plane of the first image in the virtual space, wherein the mapping plane is obtained by projecting the pixel plane of the first image to the virtual space; and
determining an axial distance between the interactive object and the mapping plane.

10. The method of claim 9, wherein determining the proportional relationship between the unit pixel distance of the first image and the unit distance of the virtual space comprises:
determining a first proportional relationship between the unit pixel distance of the first image and the unit distance of a true space;
determining a second proportional relationship between the unit distance of the true space and the unit distance of the virtual space; and
determining the proportional relationship between the unit pixel distance of the first image and the unit distance of the virtual space according to the first proportional relationship and the second proportional relationship.

11. The method of claim 1, wherein the first position of the target object in the first image comprises at least one of a position of a face of the target object or a position of a body of the target object.

12. A display device, comprising:
a transparent display screen;
at least one processor; and
one or more memories coupled to the at least one processor and storing programming instructions for execution by the at least one processor to perform operations comprising:
obtaining a first image of surroundings of the display device, wherein the display device is configured to display, on the transparent display screen, an interactive object and a virtual space where the interactive object is located;
obtaining a first position of a target object in the first image;
with a position of the interactive object in the virtual space as a reference point, determining a mapping relationship between the first image and the virtual space; and
driving the interactive object to execute an action according to the first position and the mapping relationship.

13. An electronic device, comprising:
at least one processor; and
one or more memories coupled to the at least one processor and storing programming instructions for execution by the at least one processor to perform operations comprising:
obtaining a first image of surroundings of a display device, wherein the display device is configured to display an interactive object and a virtual space where the interactive object is located;
obtaining a first position of a target object in the first image;
with a position of the interactive object in the virtual space as a reference point, determining a mapping relationship between the first image and the virtual space; and
driving the interactive object to execute an action according to the first position and the mapping relationship.

14. The electronic device of claim 13, wherein driving the interactive object to execute the action according to the first position and the mapping relationship comprises:
obtaining a corresponding second position of the target object in the virtual space by mapping the first position to the virtual space based on the mapping relationship;
driving the interactive object to execute the action according to the corresponding second position.

15. The electronic device of claim 14, wherein driving the interactive object to execute the action according to the corresponding second position comprises:
determining a first relative angle between the target object mapped to the virtual space and the interactive object according to the corresponding second position;
determining a respective weight for each of one or more body parts of the interactive object to execute the action;
according to the first relative angle and the respective weight, driving each of the one or more body parts of the interactive object to rotate a corresponding deflection angle, such that the interactive object faces toward the target object mapped to the virtual space.

16. The electronic device of claim 14, wherein image data of the virtual space and image data of the interactive object are obtained by a virtual camera device.

17. The electronic device of claim 16, wherein driving the interactive object to execute the action according to the corresponding second position comprises:
moving a position of the virtual camera device in the virtual space to the corresponding second position; and
setting a sight line of the interactive object to be aligned with the virtual camera device.

18. The electronic device of claim 14, wherein driving the interactive object to execute the action according to the corresponding second position comprises:
driving the interactive object to execute the action of moving a sight line of the interactive object to the corresponding second position.

19. The electronic device of claim 13, wherein driving the interactive object to execute the action according to the corresponding first position and the mapping relationship comprises:
obtaining a second image by mapping the first mage to the virtual space based on the mapping relationship;
dividing the first image into a plurality of first sub-regions, and dividing the second image into a plurality of second sub-regions corresponding to the plurality of first sub-regions respectively;
determining a target first sub-region where the target object is located in the plurality of first sub-regions of the first image, and determining a target second sub-region in the plurality of second sub-regions of the second image based on the target first sub-region; and
driving the interactive object to execute the action according to the target second sub-region.

20. The electronic device of claim 19, wherein driving the interactive object to execute the action according to the target second sub-region comprises:
determining a second relative angle between the interactive object and the target second sub-region; and
driving the interactive object to rotate the second relative angle such that the interactive object faces toward the target second sub-region.
